(19) United States
(12) Patent Application Publication
(10) Pub. No.: US 2020/0082430 A1
(43) Pub. Date: Mar. 12, 2020

(54) TERMINAL DEVICE, DISPLAY METHOD, AND RECORDING MEDIUM

(71) Applicant: TOYOTA JIDOSHA KABUSHIKI KAISHA, Toyota-shi (JP)

(72) Inventor: Koichi SUZUKI, Toyota-shi (JP)

(73) Assignee: TOYOTA JIDOSHA KABUSHIKI KAISHA, Toyota-shi (JP)

(21) Appl. No.: 16/512,477

(22) Filed: Jul. 16, 2019

(30) Foreign Application Priority Data
Sep. 6, 2018 (JP) 2018-167098

(51) Int. Cl. G06Q 30/02; G06Q 10/10; G06Q 10/06

(52) U.S. Cl. CPC G06Q 30/0235; G06Q 10/063116; G06Q 30/0239; G06Q 10/1093

(57) ABSTRACT

In a terminal device, a first acquirer acquires, from a user, first schedule information including a scheduled visiting place and a scheduled visiting period. A second acquirer acquires one or more pieces of recommendation information including information on a facility in or in the vicinity of the scheduled visiting place and information on a coupon that can be used at the facility. A third acquirer acquires, from the user, second schedule information including the information on a facility included in any one of the pieces of recommendation information and a scheduled visiting period at the facility. A display controller causes a display to display a schedule table including the first and the second schedule information. The display controller causes the display to display a coupon for the facility in the second schedule information in accordance with an operation of selecting the second schedule information in the schedule table.

The disclosure of Japanese Patent Application No. 2018-167098 filed on Sep. 6, 2018 including the specification, drawings and abstract is incorporated herein by reference in its entirety.

### BACKGROUND

### 1. Technical Field

The present disclosure relates to a technology for display electronic coupons.

### 2. Description of Related Art

In recent years, facilities are increasing where people can receive services by presenting coupons displayed on a smartphone or the like. Japanese Unexamined Patent Application Publication No. 2018-49336 discloses a server that receives information indicating a destination from a user's terminal device, generates route information including a movement route to the destination, extracts drop-in spots related to the destination, and transmits the drop-in spots that have been extracted to the terminal device. The server searches for coupons that can be used at the drop-in spots and transmits the coupons to the terminal device.

Japanese Unexamined Patent Application Publication No. 2018-49336 does not disclose how the user uses coupons at a facility using the terminal device. For example, when a plurality of coupons are stored in the terminal device, finding a coupon to be used may be troublesome. Accordingly, the coupons are desirably made to be easily used.

### SUMMARY

In this background, a purpose of the present embodiment is to provide a terminal device, a display method, and a recording medium that allow coupons to be easily used.

A terminal device according to one aspect of the present embodiment includes: a first acquirer configured to acquire, from a user, first schedule information including a scheduled visiting place and a scheduled visiting period; a second acquirer configured to acquire one or more pieces of recommendation information including information on a facility in or in the vicinity of the scheduled visiting place and information on a coupon that can be used at the facility; a third acquirer configured to acquire, from the user, second schedule information including the information on the facility included in any one of the pieces of recommendation information and a scheduled visiting period at the facility; and a display controller configured to cause a display to display a schedule table including the first schedule information and the second schedule information. The display controller causes the display to display the coupon for the facility according to the second schedule information in accordance with an operation of selecting the second schedule information in the schedule table.

According to this aspect, since the coupon for the facility according to the second schedule information is displayed in accordance with the operation of selecting the second schedule information in the schedule table, the coupon can be used easily.

The terminal device may include a first provider configured to provide, when the display controller has caused the display to display the coupon, information indicating that the coupon has been displayed, to a server device.

The terminal device may include a second provider configured to provide, when the third acquirer has acquired the second schedule information, information on the start point of the scheduled visiting period at the facility according to the second schedule information, to a terminal device at the facility.

When the scheduled visiting period according to the second schedule information is within the scheduled visiting period according to the first schedule information, the display controller may cause the display to display a second image representing the second schedule information over a first image representing the first schedule information.

Another aspect of the present embodiment relates to a display method. This method includes: acquiring, from a user, first schedule information including a scheduled visiting place and a scheduled visiting period; acquiring one or more pieces of recommendation information including information on a facility in or in the vicinity of the scheduled visiting place and information on a coupon that can be used at the facility; acquiring, from the user, second schedule information including the information on the facility included in any one of the pieces of recommendation information and a scheduled visiting period at the facility; causing a display to display a schedule table including the first schedule information and the second schedule information; and causing the display to display the coupon for the facility according to the second schedule information in accordance with an operation of selecting the second schedule information in the schedule table.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a block diagram showing the configuration of an information processing system according to an embodiment;

FIG. 2 is a block diagram showing the configuration of a terminal device of FIG. 1;

FIG. 3 is a block diagram showing the configuration of a server device of FIG. 1;

FIG. 4 is a diagram showing an example of a schedule table displayed on a display of the terminal device of FIG. 2;

FIG. 5 is a diagram showing an example in which a recommendation icon is displayed in the schedule table of FIG. 4;

FIG. 6 is a diagram showing an example of a list of recommendation information displayed when the recommendation icon of FIG. 5 is tapped;

FIG. 7 is a diagram showing an example in which second schedule information is registered in the schedule table of FIG. 5;

FIG. 8 is a diagram showing an example of a coupon displayed on the display;

FIG. 9 is a diagram showing another example of the schedule table in which a recommendation icon is displayed;

FIG. 10 is a diagram showing an example in which second schedule information is registered in the schedule table of FIG. 9; and

FIG. 11 is a flowchart showing a process performed by a processor in the terminal device of FIG. 2.

### DETAILED DESCRIPTION

Various embodiments now will be described. The embodiments are illustrative and are not intended to be limiting.

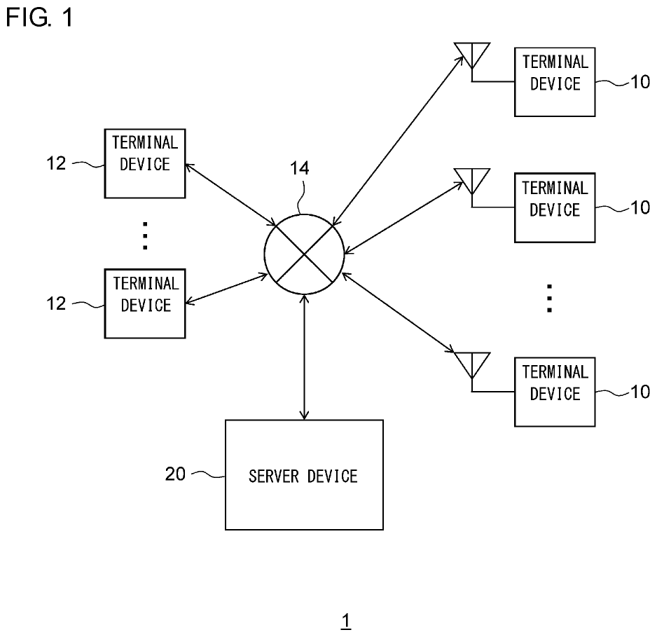

FIG. 1 is a block diagram showing the configuration of an information processing system 1 according to an embodiment. The information processing system 1 can be also referred to as a schedule management system that manages a user's schedule. The information processing system 1 also has a function of providing the user with information on a coupon for a facility such as a store in a scheduled visiting place or near the scheduled visiting place registered in the schedule. The information processing system 1 includes a plurality of terminal devices 10 used by different users, a plurality of terminal devices 12 installed in different facilities, and a server device 20.

The terminal devices 10 are, for example, portable devices such as smartphones, mobile phones, or tablet terminals carried by the users. The terminal devices 10 have a wireless communication function and connect to the network 14 via a wireless base station or a wireless access point. The terminal devices 12 are, for example, personal computers used by facility employees or the like. The terminal devices 12 connect to the network 14 through wireless communication or wired communication. The server device 20 is connected to the network 14, and the server device 20 communicates with the terminal devices 10 and the terminal devices 12 via the network 14. Communication between the terminal devices 10 and the server device 20 is performed using information for identifying the users such as user IDs. The standard of the wireless communication is not particularly limited and includes, for example, 3G (third generation mobile communication system), 4G (fourth generation mobile communication system) or 5G (fifth generation mobile communication system). The server device 20 is installed, for example, in a data center and functions as a content provider that provides content information to the terminal devices 10 based on information transmitted from the terminal devices 10. The content information includes information on a facility and information on a coupon for the facility.

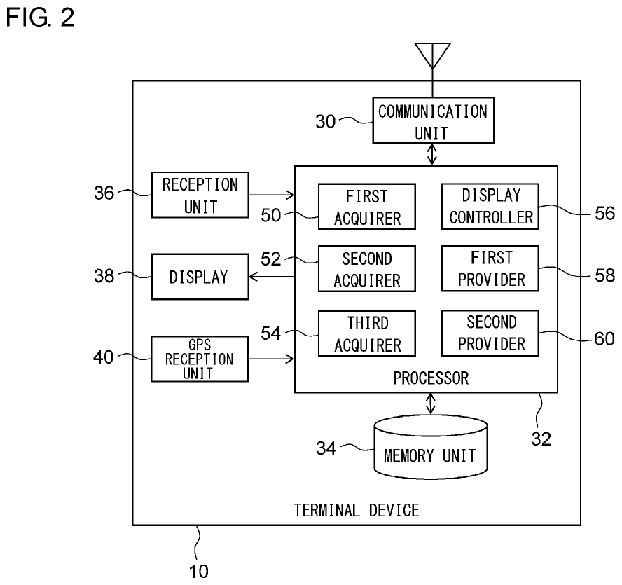

FIG. 2 is a block diagram showing the configuration of a terminal device 10 of FIG. 1. The terminal device 10 includes a communication unit 30, a processor 32, a memory unit 34, a reception unit 36, a display 38, and a GPS reception unit 40. The processor 32 includes a first acquirer 50, a second acquirer 52, a third acquirer 54, a display controller 56, a first provider 58, and a second provider 60.

The configuration of the processor 32 is implemented in hardware by any CPU of a computer, memory or other LSI's, and in software by a program or the like loaded into the memory. The figure depicts functional blocks implemented by the cooperation of hardware and software. Thus, a person skilled in the art should appreciate that there are many ways of accomplishing these functional blocks in various forms in accordance with the components of hardware only, software only, or the combination of both.

The reception unit 36 receives input of first schedule information from the user. The first schedule information includes schedule details, a scheduled visiting place, and a scheduled visiting period at the scheduled visiting place. The start point of the scheduled visiting period is the scheduled date and time, and the end point of the scheduled visiting period is the schedule ending date and time. It is assumed that the user enters these pieces of information into the schedule table displayed on the display 38.

The reception unit 36 also receives an instruction to create a movement schedule from the user. The instruction to create a movement schedule includes a departure place, a destination, and a scheduled date and time of departure from the departure place or a scheduled date and time of arrival at the destination.

The first acquirer 50 acquires the first schedule information and the instruction to create a movement schedule received by the reception unit 36 and transmits the first schedule information and the instruction to create a movement schedule that have been acquired to the server device 20 via the communication unit 30. The first acquirer 50 stores the first schedule information in the memory unit 34.

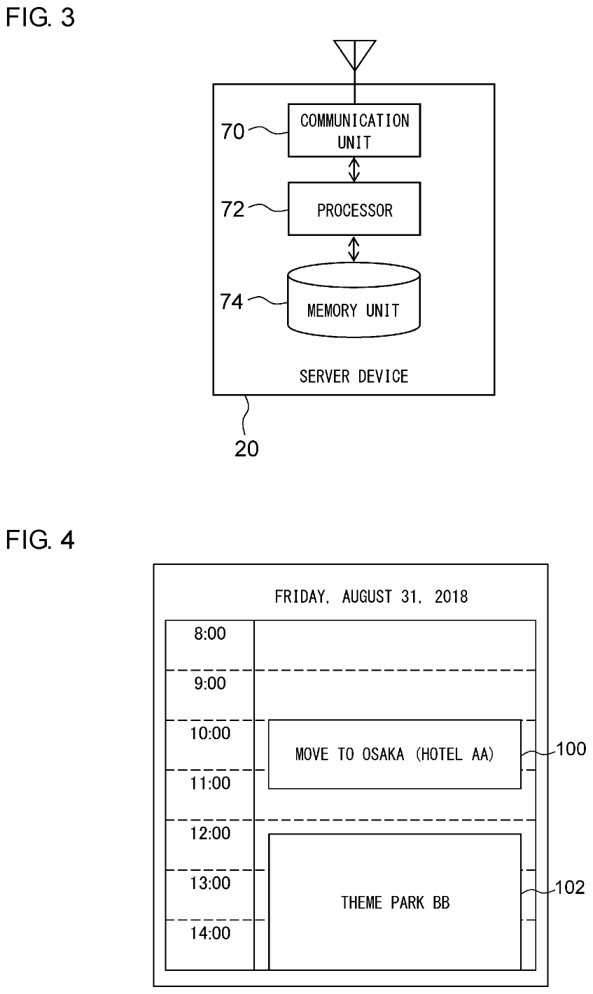

FIG. 3 is a block diagram showing the configuration of the server device 20 of FIG. 1. The server device 20 includes a communication unit 70, a processor 72, and a memory unit 74. The communication unit 70 receives the first schedule information and the instruction to create a movement schedule from the terminal device 10 and outputs the first schedule information and the like that have been received to the processor 72.

The processor 72 stores the first schedule information in the memory unit 74. The processor 72 acquires movement schedule information on movement from the departure place to the destination based on the instruction to create a movement schedule. More specifically, the processor 72 determines a means for the movement, a scheduled date and time of departure from the departure place, a scheduled date and time of arrival at the destination, a movement route from the departure place to the destination, and the charge required for the movement so that the user can depart the departure place at the scheduled date and time of departure or arrive at the destination by the scheduled date and time of arrival. The means for the movement includes cars, trains, buses, walking, etc.

The processor 72 determines, for example, a means for the movement, a movement route, and the like that achieve the shortest travel time. Well-known technology can be used to determine the means for the movement, the movement route, and the like. As the movement schedule information, the processor 72 acquires the means for the movement, the scheduled date and time of departure, the scheduled date and time of arrival, the movement route, and the charge that have been determined. The processor 72 stores the acquired movement schedule information in the memory unit 74 and outputs the movement schedule information to the communication unit 70. The communication unit 70 transmits the movement schedule information to the terminal device 10.

In the terminal device 10 of FIG. 2, the communication unit 30 receives the movement schedule information transmitted from the communication unit 70, stores the movement schedule information that has been received in the memory unit 34, and outputs the movement schedule information to the display controller 56. The display controller 56 causes the display 38 to display a schedule table including the movement schedule information in addition to the first schedule information entered by the user.

FIG. 4 shows an example of the schedule table displayed on the display 38 of the terminal device 10 of FIG. 2. The schedule table shows a daily schedule and includes an image 100 representing the movement schedule information and a first image 102 representing the first schedule information. These images are displayed along a time axis.

The image 100 representing the movement schedule information shows that the time for the scheduled date and time of departure from the house, which is the departure place, is 10:00 and that the time for the scheduled date and time of arrival at “Hotel A”, which is the destination, is 11:20. In accordance with predetermined operation input, a means for movement, a movement route, and a charge that are not displayed can also be displayed.

The first image 102 representing the first schedule information shows that the time for the scheduled date and time is 12:15, that the time for the scheduled ending date and time is 15:00, that the scheduled visiting place is “Theme park BB”, and that the schedule detail is also “Theme park BB”. The “Theme park BB” is assumed to be a facility near the “Hotel AA”. The blank space between the image 100 and the first image 102 indicates a free time with no plan.

The memory unit 74 of the server device 20 in FIG. 3 stores a plurality of sets each including information on a facility and information on a coupon that can be used at the facility in association with each other. The information on a facility includes the name of the facility, the place, etc. The information on a coupon includes the details of a service provided at the facility, a time zone in which the coupon can be used, the image information of the coupon to be displayed on the terminal device 10, and the like. The information on a coupon can be updated as appropriate.

The processor 72 sets a free time before or after the scheduled visiting period according to the first schedule information output from the communication unit 70, as a recommendation target period. When there is movement schedule information before and after the scheduled visiting period providing no free time, the processor 72 sets the scheduled visiting period, as the recommendation target period.

The processor 72 acquires one or more pieces of recommendation information including information on a facility in or in the vicinity of the scheduled visiting place according to the first schedule information and information on a coupon that can be used at the facility during the recommendation target period. The vicinity of the scheduled visiting place represents an area that is within a predetermined distance from an area representing the scheduled visiting place. The predetermined distance may be, for example, a several-minute or so walking distance and can be appropriately determined through an experiment or the like.

The processor 72 sets the order of priority to the piece(s) of recommendation information that has been acquired. The order of priority can be set using well-known technology and may be assigned in the order of closeness to the facility from a predetermined point of the scheduled visiting place or may be assigned in the order of evaluation on the facility. The processor 72 transmits, to the terminal device 10 via the communication unit 70, the recommendation information to which the order of priority has been assigned and the recommendation target period.

In the terminal device 10 of FIG. 2, when the communication unit 30 receives the recommendation information and the recommendation target period, the display controller 56 causes the display 38 to display a recommendation icon at a position indicating the recommendation target period in the schedule table.

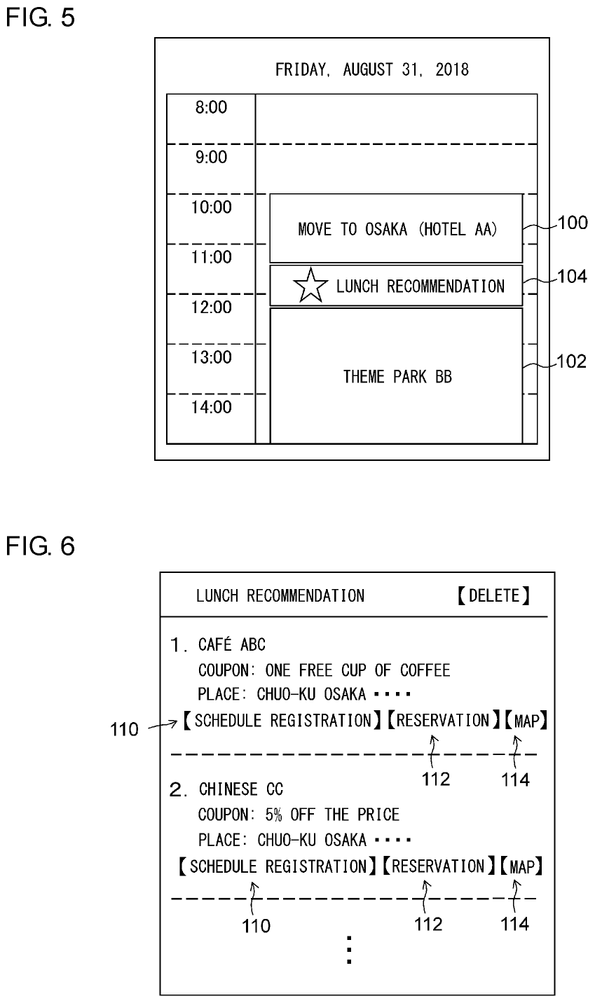

FIG. 5 shows an example in which a recommendation icon is displayed in the schedule table of FIG. 4. The schedule table further includes a recommendation icon 104 indicating “Lunch Recommendation” in addition to FIG. 4. The recommendation icon 104 indicates that the recommendation target period is between 11:25 and 12:10. The free time before the scheduled visiting period according to the first schedule information in FIG. 4 represents the recommendation target period.

When the user changes the first schedule information while the recommendation icon 104 is displayed, the display controller 56 in FIG. 2 causes the display 38 to delete the recommendation icon 104, and the communication unit 30 transmits the first schedule information after the change to the communication unit 30. The server device 20 transmits, to the terminal device 10, new recommendation information that is based on the first schedule information after the change. The display controller 56 causes the display 38 to display the recommendation icon 104 that is based on the new recommendation information. This allows the recommendation information that is suitable for the latest first schedule information to be provided.

When the reception unit 36 receives an operation of selecting the recommendation icon 104 by the user, the display controller 56 causes the display 38 to display a list of recommendation information in accordance with the order of priority. The operation of the selection is, for example, tapping.

FIG. 6 shows an example of the list of recommendation information displayed when the recommendation icon 104 of FIG. 5 is tapped. Each piece of recommendation information on the list includes a facility name such as “cafe ABC”, coupon information such as “one free cup of coffee”, the location of the facility, a schedule registration icon 110, a reservation icon 112, a map display icon 114, and the like. An operation of selecting the schedule registration icon 110 allows a visit to the corresponding facility to be registered in the schedule table. An operation of selecting the reservation icon 112 allows a reservation for the corresponding facility to be made. An operation of selecting the map display icon 114 allows a map of the surrounding areas of the corresponding facility to be displayed.

When the reception unit 36 of FIG. 2 receives the operation of selecting the schedule registration icon 110 for a facility the user desires to visit, an input screen (not shown) for a scheduled visiting period at this facility is displayed on the display 38. The reception unit 36 receives the input of the scheduled visiting period to the input screen entered by the user. The reception unit 36 receives a scheduled visiting period within the recommendation target period and does not receive a scheduled visiting period outside the recommendation target period. This is because the coupon may not be used outside the recommendation target period.

The third acquirer 54 acquires information on a facility corresponding to a schedule registration icon 110 for which the reception unit 36 has received a selection operation and a scheduled visiting period received by the reception unit 36. This corresponds to the third acquirer 54 acquiring, from the user, second schedule information including the information on the facility included in any one of the pieces of recommendation information and a scheduled visiting period at the facility.

The display controller 56 causes the display 38 to display a schedule table including the first schedule information and the second schedule information.

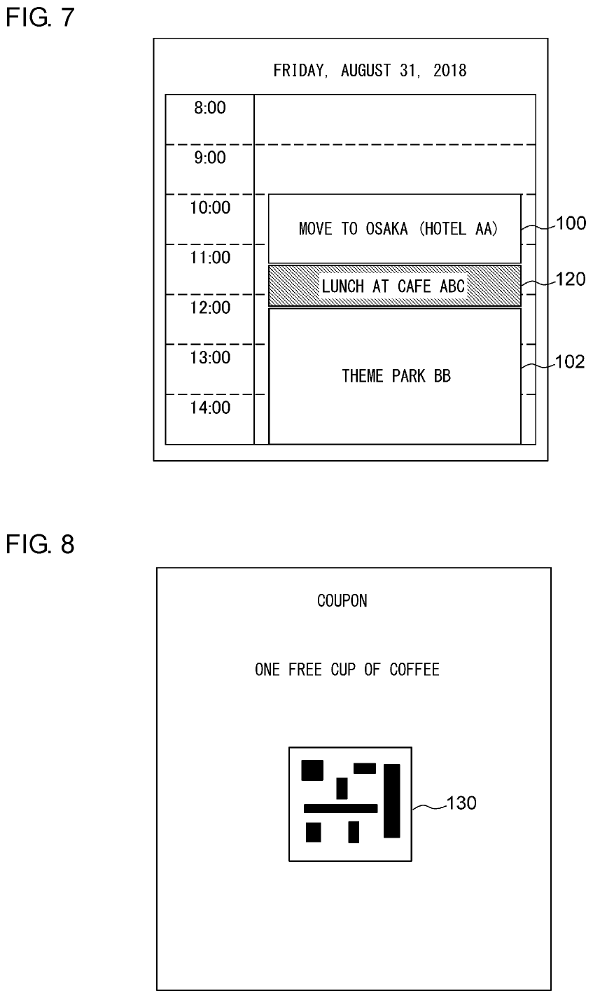

FIG. 7 shows an example in which the second schedule information is registered in the schedule table of FIG. 5. The schedule table includes a second image 120 representing the second schedule information in place of the recommendation icon 104 of FIG. 5. The second image 120 shows that the time for the start point of the scheduled visiting period is 11:25, that the time for the end point is 12:10, that the facility scheduled to be visited is “Cafe ABC”, and that the details of the schedule is “lunch at Cafe ABC”.

When the third acquirer 54 acquires the second schedule information, the second provider 60 of FIG. 2 provides the information on the start point of the scheduled visiting period (i.e., the scheduled visiting date and time) at the facility according to the second schedule information to a terminal device 12 at the facility via the server device 20. Although this process does not represent making a reservation with the facility, the date and time for possibly having a visitor can be known in advance and can thus be used for preparation or the like at the facility. Since the user has registered the second schedule information in the schedule table, the user is more likely to visit the facility compared to when the existing technology where a coupon is simply downloaded to a mobile device is used. Therefore, the information on the star point of the scheduled visiting period that is provided is likely to be useful to the facility.

The user checks the schedule table on the scheduled visiting day, visits the facility, and taps second schedule information in the schedule table. If the current position acquired by the GPS reception unit 40 indicates the position of the facility and the current date and time match the scheduled visiting date, the display controller 56 causes the display 38 to display a coupon for the facility according to the second schedule information in accordance with an operation of selecting the second schedule information in the schedule table received by the reception unit 36. Since the coupon is displayed through the tapping of the second schedule information in the schedule table for the day of the scheduled visit, the position to be tapped can be easily understood, and there is no need to look for the coupon to be displayed. Thus, it is convenient for the user to use the coupon.

FIG. 8 shows an example of a coupon displayed on the display 38. The coupon includes an information code 130 in the form of being read by a reader at a facility. The information code 130 may be anything as long as the information code 130 is for uniquely identifying the coupon and may be a two-dimensional code or a one-dimensional code. An example of a one-dimensional information code 130 is a barcode, and an example of a two-dimensional information code 130 is a QR code (registered trademark).

When the display controller 56 causes the display 38 to display a coupon, the first provider 58 in FIG. 2 provides information indicating that the coupon has been displayed to the server device 20 via the communication unit 30. When the coupon has been displayed, the coupon can be considered to have been used since the user is visiting the facility on the scheduled visiting day. When the terminal device 12 at the facility has read the coupon through the reader at the facility, the terminal device 12 may transmit information indicating that the coupon has been used, to the server device 20.

Based on the information that has been transmitted indicating that the coupon has been displayed, the processor 72 of the server device 20 in FIG. 3 sums up the percentage of users who have used the coupon out of users who have registered the second schedule information, for each facility. This percentage is expected to be higher compared to when the existing technology where coupons are simply downloaded is used and be, for example, several tens of percent. This summed up information may be provided to the facility or may be used to newly acquire a facility that provides coupons.

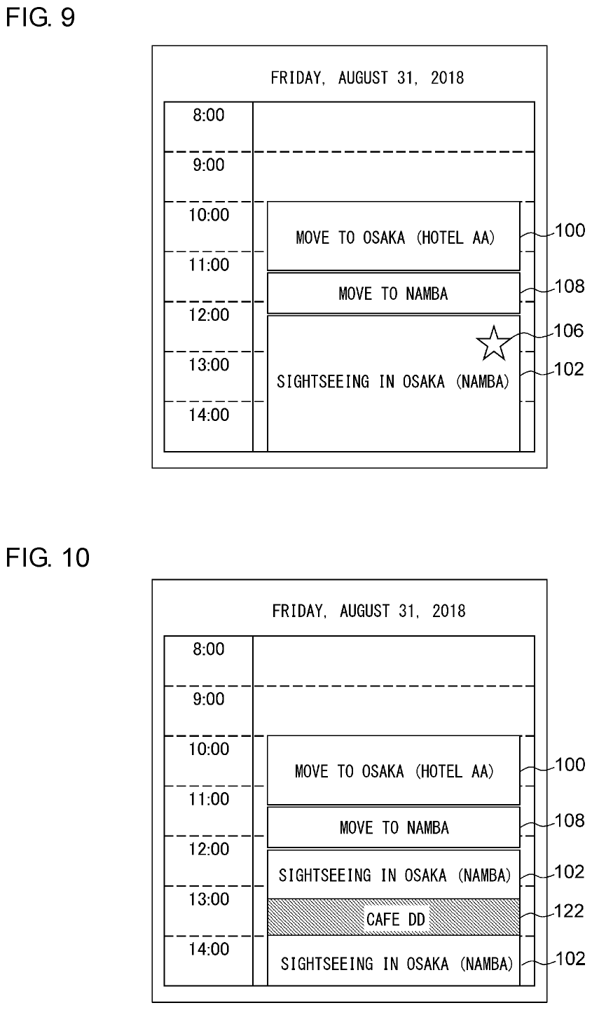

Next, an example will be described in which there is movement schedule information before the scheduled visiting period according to the first schedule information in the schedule table and there is no free time. FIG. 9 shows another example of the schedule table in which a recommendation icon is displayed. The schedule table includes, in addition to FIG. 4, an image 108 representing movement schedule information. The first schedule information is also different from that in FIG. 4. The image 108 representing the movement schedule information shows that the time for the scheduled date and time of departure from “Hotel AA” is 11:25 and that the time for the scheduled date and time of arrival in “Namba” representing the name of an area is 12:10.

The first image 102 representing the first schedule information shows that the scheduled visiting place is “Namba” and that the schedule detail is “Sightseeing in Osaka”. The scheduled visiting place may be an area, as in this example. The scheduled visiting period is the same as that in FIG. 4. Although illustration is omitted, it is assumed that there is also movement schedule information after the scheduled visiting period according to the first schedule information.

Since there is no free time before or after the scheduled visiting period according to the first schedule information, the processor 72 of the server device 20 in FIG. 3 sets the scheduled visiting period as a recommendation target period. Therefore, a recommendation icon 106 is displayed over the first image 102 that represents the first scheduled information.

After this, as in the process described above, second schedule information is acquired from a list of recommendation information displayed in accordance with an operation of selecting the recommendation icon 106. In the example of FIG. 9, the scheduled visiting period according to the second schedule information is a period designated by the user within the scheduled visiting period according to the first schedule information.

When the scheduled visiting period according to the second schedule information is within the scheduled visiting period according to the first schedule information, the display controller 56 in FIG. 2 causes the display 38 to display the second image representing the second schedule information over the first image 102 representing the first schedule information. In other words, it can be said that the display controller 56 causes the display 38 to display the second image representing the second schedule information in such a manner that the second image is squeezed in the first image 102 representing the first schedule information.

FIG. 10 shows an example in which the second schedule information is registered in the schedule table of FIG. 9. The schedule table further includes a second image 122 representing the second schedule information that is displayed over the first image 102 representing the first schedule information. The second image 122 shows that the time for the start point of the scheduled visiting period is 13:20, that the time for the end point is 14:00, that the facility scheduled to be visited is “Cafe DD”, and that the details of the schedule is “Cafe DD”. As described above, the second schedule information can be easily added over the existing first schedule information in accordance with the user's request. After this, the above-described process is performed.

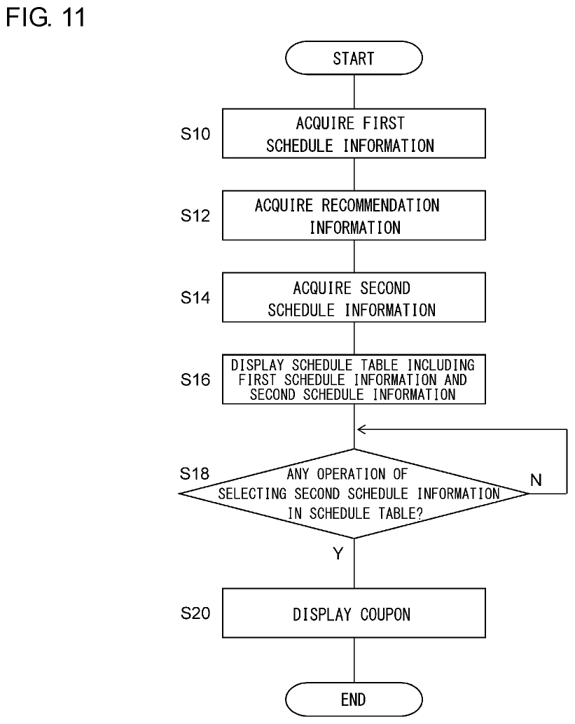

The overall operation of a terminal device 10 having the above features will be described. FIG. 11 is a flowchart showing a process performed by the processor 32 in the terminal device 10 of FIG. 2. The first acquirer 50 acquires, from the user, first schedule information including a scheduled visiting place and a scheduled visiting period (S10). The second acquirer 52 acquires one or more pieces of recommendation information (S12). The third acquirer 54 acquires, from the user, second schedule information including the information on a facility included in any one of the pieces of recommendation information and a scheduled visiting period at the facility (S14). The display controller 56 causes a schedule table including the first schedule information and the second schedule information to be displayed (S16). If there is an operation of selecting the second schedule information in the schedule table (Y in S18), the display controller 56 causes a coupon for the facility according to the second schedule information to be displayed (S20) and ends the process. If there is no operation of selecting the second schedule information (N in S18), the step goes back to Step S18.

According to the present embodiment, since the coupon for the facility according to the second schedule information is displayed in accordance with the operation of selecting the second schedule information in the schedule table, the operation for displaying the desired coupon is easy to understand, and the coupon can thus be used easily.

Described above is an explanation based on exemplary embodiments. The embodiments are intended to be illustrative only, and it will be obvious to those skilled in the art that various modifications to a combination of constituting elements or processes could be developed and that such modifications also fall within the scope of the present disclosure.

What is claimed is:

1. A terminal device comprising:
a first acquirer configured to acquire, from a user, first schedule information including a scheduled visiting place and a scheduled visiting period;
a second acquirer configured to acquire one or more pieces of recommendation information including information on a facility in or in the vicinity of the scheduled visiting place and information on a coupon that can be used at the facility;
a third acquirer configured to acquire, from the user, second schedule information including the information on the facility included in any one of the pieces of recommendation information and a scheduled visiting period at the facility; and
a display controller configured to cause a display to display a schedule table including the first schedule information and the second schedule information,
wherein the display controller causes the display to display the coupon for the facility according to the second schedule information in accordance with an operation of selecting the second schedule information in the schedule table.

2. The terminal device according to claim 1, comprising a first provider configured to provide, when the display controller has caused the display to display the coupon, information indicating that the coupon has been displayed, to a server device.

3. The terminal device according to claim 1, comprising a second provider configured to provide, when the third acquirer has acquired the second schedule information, information on the start point of the scheduled visiting period at the facility according to the second schedule information, to a terminal device at the facility.

4. The terminal device according to claim 1, wherein, when the scheduled visiting period according to the second schedule information is within the scheduled visiting period according to the first schedule information, the display controller causes the display to display a second image representing the second schedule information over a first image representing the first schedule information.

5. A display method comprising:
acquiring, from a user, first schedule information including a scheduled visiting place and a scheduled visiting period;
acquiring one or more pieces of recommendation information including information on a facility in or in the vicinity of the scheduled visiting place and information on a coupon that can be used at the facility;
acquiring, from the user, second schedule information including the information on the facility included in any one of the pieces of recommendation information and a scheduled visiting period at the facility;
causing a display to display a schedule table including the first schedule information and the second schedule information; and
causing the display to display the coupon for the facility according to the second schedule information in accordance with an operation of selecting the second schedule information in the schedule table.

6. A non-transitory computer-readable recording medium encoded with a program comprising computer-implemented modules including:
a module that acquires, from a user, first schedule information including a scheduled visiting place and a scheduled visiting period;
a module that acquires one or more pieces of recommendation information including information on a facility in or in the vicinity of the scheduled visiting place and information on a coupon that can be used at the facility;
a module that acquires, from the user, second schedule information including the information on the facility included in any one of the pieces of recommendation information and a scheduled visiting period at the facility;
a module that causes a display to display a schedule table including the first schedule information and the second schedule information; and
a module that causes the display to display the coupon for the facility according to the second schedule information in accordance with an operation of selecting the second schedule information in the schedule table.
